(19) United States
(12) Patent Application Publication
(10) Pub. No.: US 2008/0075649 A1
(43) Pub. Date: Mar. 27, 2008

(54) METHODS AND APPARATUS FOR THE PRODUCTION OF ULTRAFINE PARTICLES

(75) Inventors: Cheng-Hung Hung, Wexford, PA (US); Noel R. Vanier, Wexford, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/534,346

(22) Filed: Sep. 22, 2006

(51) Int. Cl. C01B 33/12

(52) U.S. Cl. 423/335; 423/625

(57) ABSTRACT

Disclosed are methods for making ultrafine particles. These methods include (a) introducing a plurality of precursors to a high temperature chamber, the precursors including a first precursor and a second precursor different from the first precursor and comprising an alkali metal dopant; (b) heating the plurality of precursors in the high temperature chamber, yielding a gaseous product stream; (c) quenching the gaseous product stream, thereby producing ultrafine particles; and (d) collecting the ultrafine particles. Also disclosed are apparatus for the production of ultrafine particles, ultrafine particles produced from a plurality of precursors and coating compositions and coated substrates that include ultrafine particles.

### FIELD OF THE INVENTION

The present invention relates to methods and apparatus for the production of ultrafine particles. The present invention also relates to ultrafine particles produced by the method and compositions, such as coating compositions, comprising such ultrafine particles.

### BACKGROUND OF THE INVENTION

Ultrafine particles have become desirable for use in many applications. As the average primary particle size of a material decreases to less than 1 micron a variety of confinement effects can occur that can change the properties of the material. For example, a property can be altered when the entity or mechanism responsible for that property is confined within a space smaller than some critical length associated with that entity or mechanism. As a result, ultrafine particles represent an opportunity for designing and developing a wide range of materials for structural, optical, electronic and chemical applications, such as coatings.

Various methods have been employed to make ultrafine particles. Among these are various vapor phase synthesis methods, such as flame pyrolysis, hot walled reactor, chemical vapor synthesis, and rapid quench plasma synthesis, among others. Regardless of which vapor phase synthesis technique is used, it would be desirable a method for further reducing, and controlling, the average primary particle size of the resulting material. In addition, it would be desirable if such methods do not significantly reduce the throughput of the process selected from making the ultrafine particles.

### SUMMARY OF THE INVENTION

In certain respects, the present invention is directed to methods for making ultrafine particles. These methods comprise: (a) introducing a plurality of precursors to a high temperature chamber, the precursors comprising: (i) a first precursor; and (ii) a second precursor different from the first precursor and comprising an alkali metal dopant; (b) heating the plurality of precursors in the high temperature chamber, yielding a gaseous product stream; (c) quenching the gaseous product stream, thereby producing ultrafine particles; and (d) collecting the ultrafine particles.

In other respects, the present invention is directed to methods for reducing the average primary particle size of ultrafine particles made by a vapor phase synthesis process. These methods comprise: (a) including an alkali metal dopant in a precursor stream to a high temperature chamber, wherein the precursor stream comprises a precursor which is different from the alkali metal dopant; (b) heating the precursor stream in the high temperature chamber, yielding a gaseous product stream; (c) quenching the gaseous product stream, thereby producing ultrafine particles; and (d) collecting the ultrafine particles.

In still other respects, the present invention is directed to a plasma reactor apparatus for the production of ultrafine particles. The apparatus comprises: (a) a plasma chamber having axially spaced inlet and outlet ends; (b) a high temperature plasma positioned at the inlet end of the plasma chamber; (c) an inlet for introducing a precursor stream to the plasma chamber, the precursor stream comprising: (i) a first precursor; and (ii) a second precursor different from the first precursor and comprising an alkali metal dopant, wherein the precursor stream is heated by the plasma to produce a gaseous product stream flowing toward the outlet end of the plasma chamber; (d) means for quenching the gaseous product stream, thereby producing ultrafine particles, and (e) means for collecting the ultrafine particles.

In yet other respects, the present invention is directed to methods for reducing the average primary particle size of ultrafine particles produced from a precursor in a vapor phase synthesis process. Such methods comprise including an alkali metal dopant in a stream comprising the precursor prior to the precursor being heated in a high temperature chamber.

The present invention also relates to ultrafine particles as well as coating compositions comprising such particles.

### BRIEF DESCRIPTION OF THE DRAWINGS

FIGS. 1A and 1B are flowcharts depicted the steps of certain methods of the present invention;

FIGS. 2A and 2B are schematic views of apparatus for producing ultrafine particles in accordance with certain embodiments of the present invention; and

FIG. 3 is a detailed perspective view of a plurality of quench stream injection ports in accordance with certain embodiments of the present invention.

### DETAILED DESCRIPTION OF EMBODIMENTS OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As indicated, certain embodiments of the present invention are directed to methods and/or apparatus for making ultrafine particles. As used herein, the term “ultrafine particles” refers to particles having a B.E.T. specific surface area of at least 10 square meters per gram, such as 30 to 500 square meters per gram, or, in some cases, 90 to 500 square meters per gram or, in yet other cases, 180 to 500 square meters per gram. As used herein, the term “B.E.T. specific surface area” refers to a specific surface area determined by nitrogen adsorption according to the ASTMD 3663-78 standard based on the Brunauer-Emmett-Teller method described in the periodical “The Journal of the American Chemical Society”, 60, 309 (1938).

In certain embodiments, the ultrafine particles made in accordance with the present invention have a calculated equivalent spherical diameter of no more than 200 nanometers, such as no more than 100 nanometers, or, in certain embodiments, 5 to 50 nanometers, or, in yet other cases, 5 to 20 nanometers. As will be understood by those skilled in the art, a calculated equivalent spherical diameter can be determined from the B.E.T. specific surface area according to the following equation:

Diameter (nanometers)=6000/[BET(m²/g)*ρ(grams/cm³)]

In certain embodiments, the ultrafine particles produced in accordance with the present invention have an average primary particle size of no more than 100 nanometers, in some cases, no more than 50 nanometers or, in yet other cases, no more than 20 nanometers or, in other cases, no more than 12 nanometers. As used herein, the term “primary particle size” refers to a particle size as determined by visually examining a micrograph of a transmission electron microscopy (“TEM”) image, measuring the diameter of the particles in the image, and calculating the average primary particle size of the measured particles based on magnification of the TEM image. One of ordinary skill in the art will understand how to prepare such a TEM image and determine the primary particle size based on the magnification. The primary particle size of a particle refers to the smallest diameter sphere that will completely enclose the particle. As used herein, the term “primary particle size” refers to the size of an individual particle as opposed to an agglomeration of two or more individual particles.

The ultrafine particles described herein may be prepared by virtually any gas phase synthesis process, including, for example, flame pyrolysis, hot walled reactor, chemical vapor synthesis, and rapid quench plasma synthesis. In certain embodiments of the present invention, the ultrafine particles are produced by a method comprising: (a) introducing a plurality of precursors to a high temperature chamber, the precursors comprising: (i) a first precursor; and (ii) a second precursor different from the first precursor and comprising an alkali metal dopant; (b) heating the plurality of precursors in the high temperature chamber, yielding a gaseous product stream; (c) quenching the gaseous product stream, thereby producing ultrafine particles; and (d) collecting the ultrafine particles.

In certain embodiments, such a process comprises combining the first precursor and the second precursor in a fast quench plasma system. In certain embodiments, the particles are produced by a process comprising: (a) introducing a plurality of precursors to a high temperature chamber, the precursors comprising: (i) a first precursor; and (ii) a second precursor different from the first precursor and comprising an alkali metal dopant; (b) rapidly heating the first precursor and the second precursor by means of a plasma to yield a gaseous product stream; (c) passing the gaseous product stream through a restrictive convergent-divergent nozzle to effect rapid cooling and/or utilizing an alternative cooling method, such as a cool surface or quenching stream, and (d) condensing the gaseous product stream to yield ultrafine particles. In certain embodiments, such a process comprises: (a) introducing the first precursor and the second precursor into one axial end of a plasma chamber; (b) rapidly heating the first precursor and the second precursor by means of a plasma as they flow through the plasma chamber, yielding a gaseous product stream; (c) passing the gaseous product stream through a restrictive convergent-divergent nozzle arranged coaxially within the end of the reaction chamber; and (d) subsequently cooling and slowing the velocity of the desired end product exiting from the nozzle, yielding ultrafine particles.

In certain embodiments, the ultrafine particles described herein are produced by a method comprising: (a) introducing a plurality of precursors into a plasma chamber, wherein the plurality of precursors comprise: (i) a first precursor, and (ii) a second precursor different from the first precursor and comprising an alkali metal dopant; (b) heating the precursors by means of a plasma as the precursor flow through a plasma chamber, yielding a gaseous product stream; (c) contacting the gaseous product stream with a plurality of quench streams injected into the plasma chamber through a plurality of quench stream injection ports, wherein the quench streams are injected at flow rates and injection angles that result in impingement of the quench stream with each other within the gaseous product stream, thereby producing ultrafine particles; (d) passing the ultrafine particles through a converging member; and (e) collecting the ultrafine particles.

In certain embodiments, the ultrafine particles described herein are produced by a method comprising: (a) introducing a plurality of precursors into a plasma chamber, wherein the plurality of precursors comprise: (i) a first precursor, and (ii) a second precursor different from the first precursor and comprising an alkali metal dopant; (b) heating the precursors by means of a plasma as the precursor flow through a plasma chamber, yielding a gaseous product stream; (c) passing the gaseous product stream through a converging member, and then (d) contacting the gaseous product stream with a plurality of quench streams injected into the plasma chamber through a plurality of quench stream injection ports, wherein the quench streams are injected at flow rates and injection angles that result in impingement of the quench stream with each other within the gaseous product stream, thereby producing ultrafine particles; and (e) collecting the ultrafine particles.

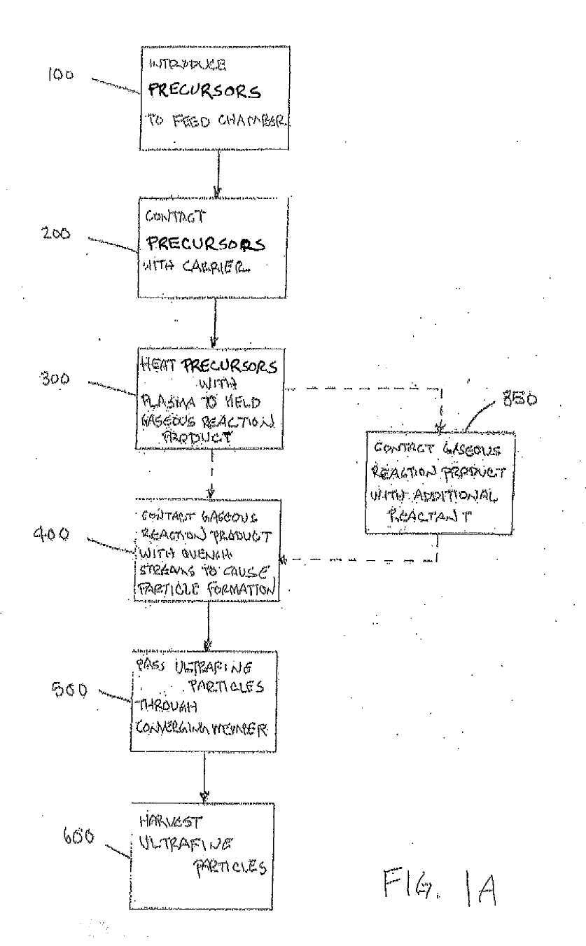

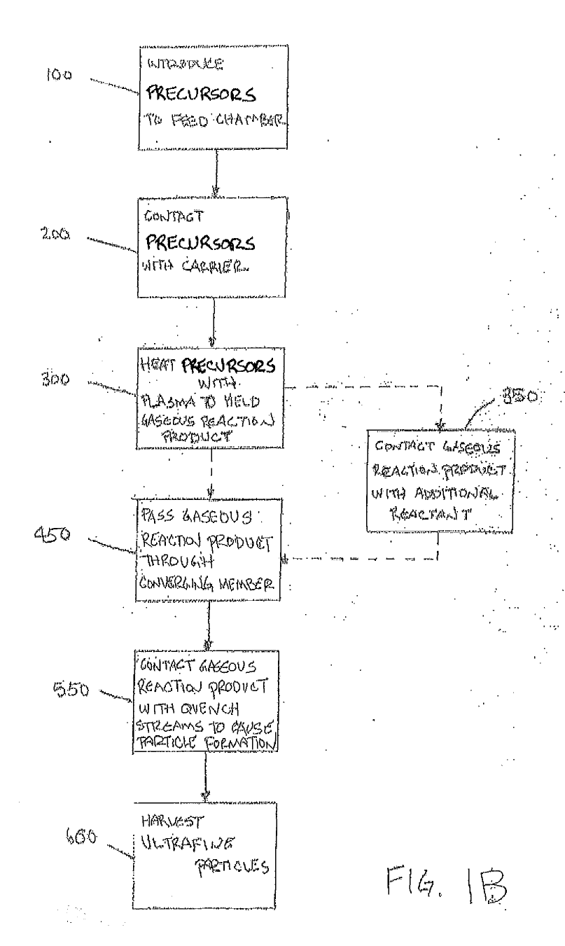

Referring now to FIGS. 1A and 1B, there are seen flow diagrams depicting certain embodiments of the methods of the present invention. As is apparent, certain embodiments of the present invention are directed to methods for making ultrafine particles in a high temperature chamber, such as a plasma system, wherein, at step 100, a plurality of precursors are introduced into a feed chamber. As used herein, the term “precursor” refers to a substance from which a desired product is formed. In the present invention, the plurality of precursors comprises: (i) a first precursor; and (ii) a second precursor different from the first precursor and comprising an alkali metal dopant.

In the present invention the first precursor may comprise virtually any material, depending upon the desired composition of the ultrafine particles. The first precursor may be introduced as a solid, liquid, gas, or a mixture thereof. In certain embodiments, the first precursor is introduced as a liquid. In certain embodiments, the first precursor comprises an organometallic material, such as, for example, cerium-2 ethylhexanoate, zinc phosphate silicate, zinc-2 ethylhexanoate, calcium methoxide, triethylphosphate, lithium 2,4 pentanedionate, yttrium butoxide, molybdenum oxide bis(2,4-pentanedionate), trimethoxyboroxine, aluminum sec-butoxide, and trimethylborate, among other materials, including mixtures thereof. In certain embodiments, such as when ultrafine silica particles are desired, the organometallic comprises an organosilane. Suitable organosilanes include those comprising two, three, four, or more alkoxy groups. Specific examples of suitable organosilanes include methyltrimethoxysilane, methyltriethoxysilane, methyltrimethoxysilane, methyltriacetoxysilane, methyltripropoxysilane, methyltributoxysilane, ethyltrimethoxysilane, ethyltriethoxysilane, γ-meth-acryloxypropyltrimethoxysilane, γ-aminopropyltrimethoxysilane, γ-aminopropyltriethoxysilane, γ-mercaptopropyltrimethoxysilane, chloromethyltrimethoxysilane, chloromethytriethoxysilane, dimethyldiethoxysilane, γ-chloropropylmethyldimethoxysilane, γ-chloropropylmethyldiethoxysilane, tetramethoxysilane, tetraethoxysilane, tetra-n-propoxysilane, tetra-n-butoxysilane, glycidoxymethyltriethoxysilane, α-glycidoxyethyltrimethoxysilane, α-glycidoxyethyltriethoxysilane, β-glycidoxyethyltrimethoxysilane, β-glycidoxyethyltriethoxysilane, α-glycidoxy-propyltrimethoxysilane, α-glycidoxypropyltriethoxysilane, β-glycidoxypropyltrimethoxysilane, β-glycidoxypropyltriethoxysilane, γ-glycidoxypropyltrimethoxysilane, γ-glycidoxypropylmethyldimethoxysilane, γ-glycidoxy-propyldimethylethoxysilane, hydrolyzates thereof, oligomers and mixtures thereof.

In certain embodiments, the first precursor comprises an oxide and/or a metal salt. Suitable solid precursors that may be used as part of the first precursor stream include solid silica powder (such as silica fume, fumed silica, silica sand, and/or precipitated silica), cerium acetate, cerium oxide, boron carbide, silicon carbide, titanium dioxide, magnesium oxide, tin oxide, zinc oxide, aluminum oxide, bismuth oxide, tungsten oxide, molybdenum oxide, and other oxides, among other materials, including mixtures thereof.

The second precursor, in accordance with certain embodiments of the present invention, is different from the first precursor and comprises an alkali metal dopant. In certain embodiments, the second precursor consists of only an alkali metal containing material. As used herein, the term “alkali metal dopant” refers to a material that comprises an alkali metal. As used herein, the term “alkali metal” refers to the metals found in Group IA of the Periodic Table of Elements, i.e., lithium (Li), sodium (Na), potassium (K), rubidium (Rb), cesium (Cs), and francium (Fr). The second precursor may be introduced as a solid, liquid, gas, or a mixture thereof. In certain embodiments, the second precursor is introduced as a liquid. Alkali metal containing materials suitable for use as the second precursor include alkali metal oxides and alkali metal salts, such as alkali metal acetates, carbonates, and/or nitrates. Specific examples include cesium acetate, cesium nitrate, cesium ammonium nitrate, cesium carbonate, cesium chloride, cesium fluoride, cesium oxide, sodium nitrate, sodium nitrite, sodium acetate, sodium chloride, sodium carbonate, sodium oxide, sodium fluoride, potassium carbonate, potassium oxide, potassium nitrate, potassium chloride, among other materials, including mixtures thereof.

As used herein, the term “dopant” refers a material that is affirmatively added in a relatively small amount relative to at least one other material to alter properties of the other material. As a result, for purposes of the present invention, the term “dopant” should be distinguished from, and does not include, incidental alkali metal impurities that may be associated with the first precursor. As indicated, the alkali metal precursor is added in a relatively small amount in comparison to the first precursor. More particularly, in certain embodiments, the alkali metal precursor is introduced in an amount such that the ultrafine particles produced by the method of the present invention theoretically include from 0.01 to 15 weight percent, such as 0.01 to 5 weight percent, in some cases 0.05 to 5 weight percent, or, in some cases, 0.1 to 2 weight percent of the alkali metal component, with weight percent being based on the total weight of the ultrafine particle. The theoretical composition of ultrafine particles produced in accordance with the present invention is determined in the manner described in the Examples herein.

It has been surprisingly discovered that several benefits result from the methods and apparatus for making ultrafine particles of the present invention, wherein a precursor comprising an alkali metal dopant is used in combination with another, different precursor, such as a silica and/or alumina precursor. First, such a combination has, in at least some cases, provided a significant reduction in the average primary particle size (i.e., a significant increase in the B.E.T. specific surface area) of the ultrafine particles produced, as compared to utilizing an identical process absent the use of a second precursor comprising an alkali metal dopant. In some cases, the average primary particle size has been reduced by 50% or, in some cases, 100% or more. Moreover, such particle size reductions have been achieved without any significant effect on the process throughput. Second, such a combination has resulted in the production of ultrafine particles having substantially modified surface characteristics, as compared to utilizing an identical process absent the use of a second precursor comprising an alkali metal dopant. For example, ultrafine particles made using the methods and apparatus of the present invention have, in at least some cases, exhibited pH values several units higher than ultrafine particles utilizing an identical process absent the use of a second precursor comprising an alkali metal dopant. This ability to control the surface chemistry of the ultrafine particles results in the ability to produce ultrafine particles that can more easily be dispersed in an aqueous medium, such as is often used in coating compositions.

In accordance with certain methods of the present invention, as is apparent from FIGS. 1A and 1B at step 200, the first precursor and the second precursor are contacted with a carrier. The carrier may be a gas that acts to suspend the precursors in the gas, thereby producing a gas-stream suspension of the precursors. Suitable carrier gases include, but are not limited to, argon, helium, nitrogen, oxygen, air, hydrogen, or a combination thereof.

Next, in accordance with certain methods of the present invention, the precursors are heated, at step 300, by means of a plasma as the precursors flow through the plasma chamber, yielding a gaseous product stream. In certain embodiments, the precursor is heated to a temperature ranging from 2,500° to 20,000° C., such as 1,700° to 8,000° C.

In certain embodiments, the gaseous product stream may be contacted with a reactant, such as a hydrogen-containing material, that may be injected into the plasma chamber, as indicated at step 350. The particular material used as the reactant is not limited, and may include, for example, air, water vapor, hydrogen gas, ammonia, and/or hydrocarbons, depending on the desired properties of the resulting ultrafine particles.

As is apparent from FIG. 1A, in certain methods of the present invention, after the gaseous product stream is produced, it is, at step 400, contacted with a plurality of quench streams that are injected into the plasma chamber through a plurality of quench stream injection ports, wherein the quench streams are injected at flow rates and injection angles that result in impingement of the quench streams with each other within the gaseous product stream. The material used in the quench streams is not limited, so long as it adequately cools the gaseous product stream to cause formation of ultrafine particles. Thus, as used herein, the term “quench stream” refers to a stream that cools the gaseous product stream to such an extent so as to cause formation of ultrafine particles. Materials suitable for use in the quench streams include, but are not limited to, hydrogen gas, carbon dioxide, air, water vapor, ammonia, mono, di and polybasic alcohols, silicon-containing materials (such as hexamethyldisilazane), carboxylic acids, and/or hydrocarbons.

The particular flow rates and injection angles of the various quench streams may vary, so long as, in certain embodiments, they impinge with each other within the gaseous product stream to result in the rapid cooling of the gaseous product stream to produce ultrafine particles. This differentiates certain embodiments of the present invention from certain fast quench plasma systems that primarily or exclusively utilize Joule-Thompson adiabatic and isoentropic expansion through, for example, the use of a converging-diverging nozzle or a “virtual” converging-diverging nozzle, to form ultrafine particles. In these embodiments of the present invention, the gaseous product stream is contacted with the quench streams to produce ultrafine particles before passing those particles through a converging member, such as, for example, a converging-diverging nozzle, which the inventors have surprisingly discovered aids in, inter alia, reducing the fouling or clogging of the plasma chamber, thereby enabling the production of ultrafine particles without frequent disruptions in the production process for cleaning of the plasma system. In these embodiments of the present invention, the quench streams primarily cool the gaseous product stream through dilution, rather than adiabatic expansion, thereby causing a rapid quenching of the gaseous product stream and the formation of ultrafine particles prior to passing the particles into and through a converging member.

As used herein, the term “converging member” refers to a device that includes at least a section or portion that progresses from a larger diameter to a smaller diameter in the direction of flow, thereby restricting passage of a flow therethrough, which can permit control of the residence time of the flow in the plasma chamber due to a pressure differential upstream and downstream of the converging member. In certain embodiments, the converging member is a conical member, i.e., a member whose base is relatively circular and whose sides taper towards a point, whereas, in other embodiments, the converging member is a converging-diverging nozzle of the type described in U.S. Pat. No. RE 37,853 at col. 9, line 65 to col. 11, line 32, the cited portion of which being incorporated herein by reference.

Referring again to FIG. 1A, it is seen that, in certain embodiments, after contacting the gaseous product stream with the quench stream to cause production of ultrafine particles, the ultrafine particles are, at step 500, passed through a converging member, whereas, in other embodiments, as illustrated in FIG. 1B, the gaseous product stream is passed through a converging member at step 450 prior to contacting the stream with the quench streams to cause production of ultrafine particles at step 550. In either of these embodiments, while the converging member may act to cool the product stream to some degree, the quench streams perform much of the cooling so that a substantial amount of ultrafine particles are formed upstream of the converging member in the embodiment illustrated by FIG. 1A or downstream of the converging member in the embodiment illustrated by FIG. 1B. Moreover, in either of these embodiments, the converging member may primarily act as a choke position that permits operation of the reactor at higher pressures, thereby increasing the residence time of the materials therein. The combination of quench stream dilution cooling with a converging member appears to provide a commercially viable method of producing ultrafine particles using a plasma system, since, for example, (i) the precursors can be used effectively without heating the feed material to a gaseous or liquid state before injection into the plasma, and (ii) fouling of the plasma system can be minimized, or eliminated, thereby reducing or eliminating disruptions in the production process for cleaning of the system.

As is seen in FIGS. 1A and 1B, in certain embodiments of the methods of the present invention, after the ultrafine particles are produced, they are collected at step 600. Any suitable means may be used to separate the ultrafine particles from the gas flow, such as, for example, a bag filter or cyclone separator.

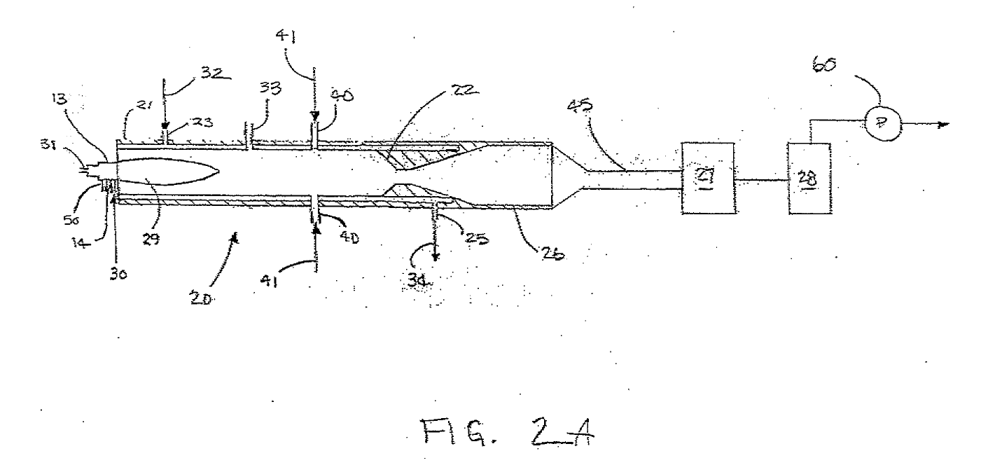

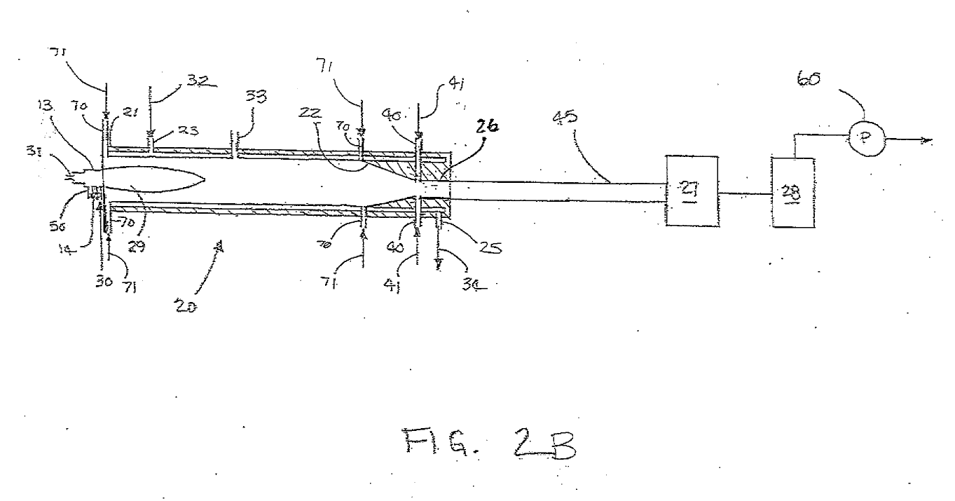

Now referring to FIGS. 2A and 2B, there are depicted schematic diagrams of an apparatus for producing ultrafine particles in accordance with certain embodiments of the present invention. As is apparent, in these embodiments, a plasma chamber 20 is provided that includes a precursor feed inlet 50. In certain embodiments, the first precursor and the second precursor are combined (not shown) prior to inlet 50. Also provided is at least one carrier gas feed inlet 14, through which a carrier gas flows in the direction of arrow 30 into the plasma chamber 20. As previously indicated, the carrier gas may act to suspend precursors therein, thereby producing a gas-stream suspension of the precursors which flows towards plasma 29. Numerals 23 and 25 designate cooling inlet and outlet respectively, which may be present for a double-walled plasma chamber 20. In these embodiments, coolant flow is indicated by arrows 32 and 34. Suitable coolants include both liquids and gasses depending upon the selected reactor geometry and materials of construction.

In the embodiments depicted by FIGS. 2A and 2B, a plasma torch 21 is provided. Torch 21 thermally decomposes the incoming gas-stream suspension of precursors within the resulting plasma 29 as the stream is delivered through the inlet of the plasma chamber 20, thereby producing a gaseous product stream. As is seen in FIGS. 2A and 2B, the precursors are, in certain embodiments, injected downstream of the location where the arc attaches to the annular anode 13 of the plasma generator or torch.

A plasma is a high temperature luminous gas which is at least partially (1 to 100%) ionized. A plasma is made up of gas atoms, gas ions, and electrons. A thermal plasma can be created by passing a gas through an electric arc. The electric arc will rapidly heat the gas by resistive and radiative heating to very high temperatures within microseconds of passing through the arc. The plasma is often luminous at temperatures above 9000 K.

A plasma can be produced with any of a variety of gases. This can give excellent control over any chemical reactions taking place in the plasma as the gas may be inert, such as argon, helium, or neon, reductive, such as hydrogen, methane, ammonia, and carbon monoxide, or oxidative, such as oxygen, nitrogen, and carbon dioxide. Air, oxygen, and/or oxygen/argon gas mixtures are often used to produce ultrafine particles in accordance with the present invention. In FIGS. 2A and 2B, the plasma gas feed inlet is depicted at 31.

As the gaseous product stream exits the plasma 29 it proceeds towards the outlet of the plasma chamber 20. As is apparent, a reactant, as described earlier, can be injected into the reaction chamber prior to the injection of the quench streams. A supply inlet for the reactant is shown in FIGS. 2A and 2B at 33.

As is seen in FIGS. 2A and 2B, in certain embodiments of the present invention, the gaseous product stream is contacted with a plurality of quench streams which enter the plasma chamber 20 in the direction of arrows 41 through a plurality of quench stream injection ports 40 located along the circumference of the plasma chamber 20. As previously indicated, the particular flow rate and injection angle of the quench streams is not limited so long as, in certain embodiments, they result in impingement of the quench streams 41 with each other within the gaseous product stream, in some cases at or near the center of the gaseous product stream, to result in the rapid cooling of the gaseous product stream to produce ultrafine particles. This results in a quenching of the gaseous product stream through dilution to form ultrafine particles.

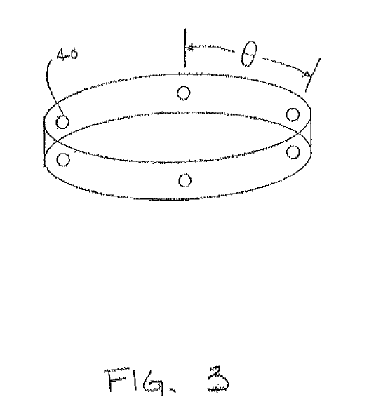

Referring now to FIG. 3, there is depicted a perspective view of a plurality of quench stream injection ports 40 in accordance with certain embodiments of the present invention. In this particular embodiment, six (6) quench stream injection ports are depicted, wherein each port is disposed at an angle “θ” apart from each other along the circumference of the reactor chamber 20. It will be appreciated that “θ” may have the same or a different value from port to port. In certain embodiments of the present invention, at least four (4) quench stream injection ports 40 are provided, in some cases at least six (6) quench stream injection ports are present or, in other embodiments, twelve (12) or more quench stream injection ports are present. In certain embodiments, each angle “θ” has a value of no more than 90°. In certain embodiments, the quench streams are injected into the plasma chamber normal (90° angle) to the flow of the gaseous reaction product. In some cases, however, positive or negative deviations from the 90° angle by as much as 30° may be used.

In certain embodiments of the present invention, such as is depicted in FIG. 2B, one or more sheath streams are injected into the plasma chamber upstream of the converging member. As used herein, the term “sheath stream” refers to a stream of gas that is injected prior to the converging member and which is injected at flow rate(s) and injection angle(s) that result in a barrier separating the gaseous product stream from the plasma chamber walls, including the converging portion of the converging member. The material used in the sheath stream(s) is not limited, so long as the stream(s) act as a barrier between the gaseous product stream and the converging portion of the converging member, as illustrated by the prevention, to at least a significant degree, of material sticking to the interior surface of the plasma chamber walls, including the converging member. For example, materials suitable for use in the sheath stream(s) include, but are not limited to, those materials described earlier with respect to the quench streams. A supply inlet for the sheath stream is shown in FIG. 2B at 70 and the direction of flow is indicated by numeral 71.

By proper selection of converging member dimensions, the plasma chamber 20 can be operated at atmospheric pressure, or slightly less than atmospheric pressure, or, in some cases, at a pressurized condition, to achieve the desired residence time, while the chamber 26 downstream of the converging member 22 is maintained at a vacuum pressure by operation of a vacuum producing device, such as a vacuum pump 60. Following production of the ultrafine particles, they may then enter a cool down chamber 26.

As is apparent from FIGS. 2A and 2B, in certain embodiments of the present invention, the ultrafine particles may flow from cool down chamber 26 to a collection station 27 via a cooling section 45, which may comprise, for example, a jacketed cooling tube. In certain embodiments, the collection station 27 comprises a bag filter or other collection means. A downstream scrubber 28 may be used if desired to condense and collect material within the flow prior to the flow entering vacuum pump 60.

In certain embodiments, the precursors are injected under pressure (such as greater than 1 to 100 atmospheres) through a small orifice to achieve sufficient velocity to penetrate and mix with the plasma. In addition, in many cases the injected stream of precursors is injected normal (90° angle) to the flow of the plasma gases. In some cases, positive or negative deviations from the 90° angle by as much as 30° may be desired.

The high temperature of the plasma rapidly vaporizes the first precursor and the second precursor comprising an alkali metal dopant. There can be a substantial difference in temperature gradients and gaseous flow patterns along the length of the plasma chamber 20. It is believed that, at the plasma arc inlet, flow is turbulent and there is a high temperature gradient; from temperatures of about 20,000 K at the axis of the chamber to about 375 K at the chamber walls.

The plasma chamber is often constructed of water cooled stainless steel, nickel, titanium, copper, aluminum, or other suitable materials. The plasma chamber can also be constructed of ceramic materials to withstand a vigorous chemical and thermal environment.

The plasma chamber walls may be internally heated by a combination of radiation, convection and conduction. In certain embodiments, cooling of the plasma chamber walls prevents unwanted melting and/or corrosion at their surfaces. The system used to control such cooling should maintain the walls at as high a temperature as can be permitted by the selected wall material, which often is inert to the materials within the plasma chamber at the expected wall temperatures. This is true also with regard to the nozzle walls, which may be subjected to heat by convection and conduction.

The length of the plasma chamber is often determined experimentally by first using an elongated tube within which the user can locate the target threshold temperature. The plasma chamber can then be designed long enough so that the materials have sufficient residence time at the high temperature to reach an equilibrium state and complete the formation of the desired end products.

The inside diameter of the plasma chamber 20 may be determined by the fluid properties of the plasma and moving gaseous stream. It should be sufficiently great to permit necessary gaseous flow, but not so large that recirculating eddies or stagnant zones are formed along the walls of the chamber. Such detrimental flow patterns can cool the gases prematurely and precipitate unwanted products. In many cases, the inside diameter of the plasma chamber 20 is more than 100% of the plasma diameter at the inlet end of the plasma chamber.

As should be appreciated from the foregoing description, the present invention is also directed to ultrafine particles, such as ultrafine silica and/or alumina particles, wherein the particles are produced from a plurality of precursors comprising: (i) a first precursor; and (ii) a second precursor different from the first precursor and comprising an alkali metal dopant. Such particles may be produced by a gas phase synthesis process, including, for example, a rapid quench plasma synthesis process as described above.

The present invention is also directed to compositions comprising ultrafine particles produced from a plurality of precursors comprising: (i) a first precursor; and (ii) a second precursor different from the first precursor and comprising an alkali metal dopant and using, for example, a method and/or apparatus of the present invention. Suitable compositions include, but are not limited to, those suitable for application to at least a portion of a surface of an object, i.e., a substrate, other suitable compositions include ceramics, composites, and dispersions. Objects to which the compositions of the present invention may be applied include animate objects, i.e., living beings, and inanimate objects, including both naturally occurring and man-made objects.

Examples of animate objects to which the compositions of the present invention may be applied include plants and animals, including human beings. For example, the ultrafine particles of the present invention may be employed in compositions that are applied to various human and/or animal substrates, such as keratin, fur, skin, teeth, nails, and the like.

As a result, in certain embodiments, the ultrafine particles of the present invention are employed in personal care products, including, for example, bath and shower gels, shampoos, conditioners, cream rinses, hair dyes, leave-on conditioners, sunscreens, sun tan lotions, body bronzers, and sunblocks, lip balms, skin conditioners, hair sprays, soaps, body scrubs, exfoliants, astringents, depilatories and permanent waving solutions, antidandruff formulations, antisweat and antiperspirant compositions, shaving, preshaving and after shaving products, moisturizers, mouthwashes, toothpastes, deodorants, cold creams, cleansers, skin gels, rinses, whether in solid, powder, liquid, cream, paste, gel, ointment, lotion, emulsions, colloids, solutions, suspensions, or other form.

In other embodiments, the ultrafine particles of the present invention are included in cosmetic compositions, including, without limitation, lipstick, mascara, rouge, foundation, blush, eyeliner, lipliner, lip gloss, facial or body powder, sunscreens and blocks, nail polish, mousse, sprays, styling gels, nail conditioner, whether in the form of creams, lotions, gels, ointments, emulsions, colloids, solutions, suspensions, compacts, solids, pencils, spray-on formulations, brush-on formulations and the like.

In yet other embodiments, the ultrafine particles of the present invention are employed in pharmaceutical preparations including, without limitation, carriers for dermatological purposes, including topical and transdermal application of pharmaceutically active ingredients. These can be in the form of gels, pastes, patches, creams, nose sprays, ointments, lotions, emulsions, colloids, solutions, suspensions, powders and the like.

In certain embodiments, the ultrafine particles of the present invention are employed in coating compositions that comprise a film-forming resin. As used herein, the term “film-forming resin” refers to resins that can form a self-supporting continuous film on at least a horizontal surface of a substrate upon removal of any diluents or carriers present in the composition or upon curing at ambient or elevated temperature.

Film-forming resins that may be used in the coating compositions of the present invention include, without limitation, those used in automotive OEM coating compositions, automotive refinish coating compositions, industrial coating compositions, architectural coating compositions, coil coating compositions, and aerospace coating compositions, among others.

In certain embodiments, the film-forming resin included within the coating compositions of the present invention comprises a thermosetting film-forming resin. As used herein, the term “thermosetting” refers to resins that “set” irreversibly upon curing or crosslinking, wherein the polymer chains of the polymeric components are joined together by covalent bonds. This property is usually associated with a cross-linking reaction of the composition constituents often induced, for example, by heat or radiation. See Hawley, Gessner G., The Condensed Chemical Dictionary, Ninth Edition., page 856; Surface Coatings, vol. 2, Oil and Colour Chemists' Association, Australia, TAFE Educational Books (1974). Curing or crosslinking reactions also may be carried out under ambient conditions. Once cured or crosslinked, a thermosetting resin will not melt upon the application of heat and is insoluble in solvents. In other embodiments, the film-forming resin included within the coating compositions of the present invention comprises a thermoplastic resin. As used herein, the term “thermoplastic” refers to resins that comprise polymeric components that are not joined by covalent bonds and thereby can undergo liquid flow upon heating and are soluble in solvents. See Saunders, K. J., Organic Polymer Chemistry, pp. 41-42, Chapman and Hall, London (1973).

Film-forming resins suitable for use in the coating compositions of the present invention include, for example, those formed from the reaction of a polymer having at least one type of reactive group and a curing agent having reactive groups reactive with the reactive group(s) of the polymer. As used herein, the term “polymer” is meant to encompass oligomers, and includes, without limitation, both homopolymers and copolymers. The polymers can be, for example, acrylic, saturated or unsaturated polyester, polyurethane or polyether, polyvinyl, cellulosic, acrylate, silicon-based polymers, co-polymers thereof, and mixtures thereof, and can contain reactive groups such as epoxy, carboxylic acid, hydroxyl, isocyanate, amide, carbamate and carboxylate groups, among others, including mixtures thereof.

Suitable acrylic polymers include, for example, those described in United States Patent Application Publication 2003/0158316 A1 at [0030]-[0039], the cited portion of which being incorporated herein by reference. Suitable polyester polymers include, for example, those described in United States Patent Application Publication 2003/0158316 A1 at [0040]-[0046], the cited portion of which being incorporated herein by reference. Suitable polyurethane polymers include, for example, those described in United States Patent Application Publication 2003/0158316 A1 at [0047]-[0052], the cited portion of which being incorporated herein by reference. Suitable silicon-based polymers are defined in U.S. Pat. No. 6,623,791 at col. 9, lines 5-10, the cited portion of which being incorporated herein by reference.

As indicated earlier, certain coating compositions of the present invention can include a film-forming resin that is formed from the use of a curing agent. As used herein, the term “curing agent” refers to a material that promotes “cure” of composition components. As used herein, the term “cure” means that any crosslinkable components of the composition are at least partially crosslinked. In certain embodiments, the crosslink density of the crosslinkable components, i.e., the degree of crosslinking, ranges from 5 percent to 100 percent of complete crosslinking, such as 35 percent to 85 percent of complete crosslinking. One skilled in the art will understand that the presence and degree of crosslinking, i.e., the crosslink density, can be determined by a variety of methods, such as dynamic mechanical thermal analysis (DMTA) using a Polymer Laboratories MK III DMTA analyzer, as is described in U.S. Pat. No. 6,803,408, at col. 7, line 66 to col. 8, line 18, the cited portion of which being incorporated herein by reference.

Any of a variety of curing agents known to those skilled in the art may be used. For example exemplary suitable aminoplast and phenoplast resins are described in U.S. Pat. No. 3,919,351 at col. 5, line 22 to col. 6, line 25, the cited portion of which being incorporated herein by reference. Exemplary suitable polyisocyanates and blocked isocyanates are described in U.S. Pat. No. 4,546,045 at col. 5, lines 16 to 38; and in U.S. Pat. No. 5,468,802 at col. 3, lines 48 to 60, the cited portions of which being incorporated herein by reference. Exemplary suitable anhydrides are described in U.S. Pat. No. 4,798,746 at col. 10, lines 16 to 50; and in U.S. Pat. No. 4,732,790 at col. 3, lines 41 to 57, the cited portions of which being incorporated herein by reference. Exemplary suitable polyepoxides are described in U.S. Pat. No. 4,681,811 at col. 5, lines 33 to 58, the cited portion of which being incorporated herein by reference. Exemplary suitable polyacids are described in U.S. Pat. No. 4,681,811 at col. 6, line 45 to col. 9, line 54, the cited portion of which being incorporated herein by reference. Exemplary suitable polyols are described in U.S. Pat. No. 4,046,729 at col. 7, line 52 to col. 8, line 9; col. 8, line 29 to col. 9, line 66; and in U.S. Pat. No. 3,919,315 at col. 2, line 64 to col. 3, line 33, the cited portions of which being incorporated herein by reference. Examples suitable polyamines described in U.S. Pat. No. 4,046,729 at col. 6, line 61 to col. 7, line 26, and in U.S. Pat. No. 3,799,854 at column 3, lines 13 to 50, the cited portions of which being incorporated herein by reference. Appropriate mixtures of curing agents, such as those described above, may be used.

In certain embodiments, the film-forming resin is present in the coating compositions of the present invention in an amount greater than 30 weight percent, such as 40 to 90 weight percent, or, in some cases, 50 to 90 weight percent, with weight percent being based on the total weight of the coating composition. When a curing agent is used, it may, in certain embodiments, be present in an amount of up to 70 weight percent, such as 10 to 70 weight percent; this weight percent is also based on the total weight of the coating composition.

In certain embodiments, the coating compositions of the present invention are in the form of liquid coating compositions, examples of which include aqueous and solvent-based coating compositions and electrodepositable coating compositions. The coating compositions of the present invention may also be in the form of a co-reactable solid in particulate form, i.e., a powder coating composition. Regardless of the form, the coating compositions of the present invention may be pigmented or clear, and may be used alone or in combination as primers, basecoats, or topcoats.

In certain embodiments, the coating compositions of the present invention may also comprise additional optional ingredients, such as those ingredients well known in the art of formulating surface coatings. Such optional ingredients may comprise, for example, surface active agents, flow control agents, thixotropic agents, fillers, anti-gassing agents, organic co-solvents, catalysts, antioxidants, light stabilizers, UV absorbers and other customary auxiliaries. Any such additives known in the art can be used, absent compatibility problems. Non-limiting examples of these materials and suitable amounts include those described in U.S. Pat. Nos. 4,220,679; 4,403,003; 4,147,769; and 5,071,904.

The coating compositions of the present invention can also include a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as pthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application No. 60/482,167 filed Jun. 24, 2003, and U.S. patent application Ser. No. 11/337,062, filed Jan. 20, 2006, which is also incorporated herein by reference.

Example special effect compositions that may be used in the coating of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference.

In general, the colorant can be present in the coating composition in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

In certain embodiments, the coating compositions of the present invention comprise ultrafine corrosion resisting particles produced from a plurality of precursors comprising: (i) a first precursor; and (ii) a second precursor different from the first precursor and comprising an alkali metal dopant, as described herein. In certain embodiments, the composition of such ultrafine particles is selected from the particles described in copending U.S. patent application Ser. No. 11/384,970 at [0021] to [0083], the relevant disclosure of which is incorporated by reference herein. As used herein, the term “corrosion resisting particles” refers to particles which, when included in a coating composition that is deposited upon a substrate, act to provide a coating that resists or, in some cases, even prevents, the alteration or degradation of the substrate, such as by a chemical or electrochemical oxidizing process, including rust in iron containing substrates and degradative oxides in aluminum substrates.

The coating compositions of the present invention may be prepared by any of a variety of methods. Coating compositions of the present invention can be prepared by first blending a film-forming resin, the ultrafine particles, and a diluent, such as an organic solvent and/or water, in a closed container that contains ceramic grind media. The blend is subjected to high shear stress conditions, such as by shaking the blend on a high speed shaker, until a homogeneous dispersion of particles remains suspended in the film-forming resin with no visible particle settle in the container. If desired, any mode of applying stress to the blend can be utilized, so long as sufficient stress is applied to achieve a stable dispersion of the particles in the film-forming resin.

Certain ultrafine particles produced in accordance with the present invention, such as ultrafine silica particles, are particularly suitable for use in sound transmission inhibiting coating compositions. Such compositions often comprise an aqueous dispersion of polymeric microparticles prepared, for example, from components comprising (i) a nitrile, amide, and/or carbamate functional material, and (ii) a polyoxyalkylene acrylate, such as is described in U.S. Pat. No. 6,531,541 at col. 3, line 49 to col. 11, line 65, the cited portion of which being incorporated by reference herein. As a result, the present invention is also directed to sound transmission inhibiting coating compositions comprising ultrafine silica particles produced by an apparatus and/or method of the present invention. In addition, the present invention is directed to methods for reducing or eliminating the amount of fumed silica in such compositions. Such methods comprising replacing at least some, if not all, of the fumed silica in the composition with ultrafine silica particles produced in accordance with the present invention.

The coating compositions of the present invention may be applied to a substrate by known application techniques, such as dipping or immersion, spraying, intermittent spraying, dipping followed by spraying, spraying followed by dipping, brushing, or by roll-coating. Usual spray techniques and equipment for air spraying and electrostatic spraying, either manual or automatic methods, can be used.

The coating compositions of the present invention are suitable for application to any of a variety of substrates, including human and/or animal substrates, such as keratin, fur, skin, teeth, nails, and the like, as well as plants, trees, seeds, agricultural lands, such as grazing lands, crop lands and the like; turf-covered land areas, e.g., lawns, golf courses, athletic fields, etc., and other land areas, such as forests and the like.

Suitable substrates include cellulosic-containing materials, including paper, paperboard, cardboard, plywood and pressed fiber boards, hardwood, softwood, wood veneer, particleboard, chipboard, oriented strand board, and fiberboard. Such materials may be made entirely of wood, such as pine, oak, maple, mahogany, cherry, and the like. In some cases, however, the materials may comprise wood in combination with another material, such as a resinous material, i.e., wood/resin composites, such as phenolic composites, composites of wood fibers and thermoplastic polymers, and wood composites reinforced with cement, fibers, or plastic cladding.

Suitable metallic substrates include, but are not limited to, foils, sheets, or workpieces constructed of cold rolled steel, stainless steel and steel surface-treated with any of zinc metal, zinc compounds and zinc alloys (including electrogalvanized steel, hot-dipped galvanized steel, GALVANNEAL steel, and steel plated with zinc alloy), copper, magnesium, and alloys thereof, aluminum alloys, zinc-aluminum alloys such as GALFAN, GALVALUME, aluminum plated steel and aluminum alloy plated steel substrates may also be used. Steel substrates (such as cold rolled steel or any of the steel substrates listed above) coated with a weldable, zinc-rich or iron phosphide-rich organic coating are also suitable for use in the process of the present invention. Such weldable coating compositions are disclosed in U.S. Pat. Nos. 4,157,924 and 4,186,036. Cold rolled steel is also suitable when pretreated with, for example, a solution selected from the group consisting of a metal phosphate solution, an aqueous solution containing at least one Group IIIB or IVB metal, an organophosphate solution, an organophosphonate solution, and combinations thereof. Also, suitable metallic substrates include silver, gold, and alloys thereof.

Examples of suitable silicatic substrates are glass, porcelain and ceramics.

Examples of suitable polymeric substrates are polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers and block copolymers, biodegradable polymers and natural polymers—such as gelatin.

Examples of suitable textile substrates are fibers, yarns, threads, knits, wovens, nonwovens and garments composed of polyester, modified polyester, polyester blend fabrics, nylon, cotton, cotton blend fabrics, jute, flax, hemp and ramie, viscose, wool, silk, polyamide, polyamide blend fabrics, polyacrylonitrile, triacetate, acetate, polycarbonate, polypropylene, polyvinyl chloride, polyester microfibers and glass fiber fabric.

Examples of suitable leather substrates are grain leather (e.g. nappa from sheep, goat or cow and box-leather from calf or cow), suede leather (e.g. velours from sheep, goat or calf and hunting leather), split velours (e.g. from cow or calf skin), buckskin and nubuk leather; further also woolen skins and furs (e.g. fur-bearing suede leather). The leather may have been tanned by any conventional tanning method, in particular vegetable, mineral, synthetic or combined tanned (e.g. chrome tanned, zirconyl tanned, aluminium tanned or semi-chrome tanned). If desired, the leather may also be re-tanned; for re-tanning there may be used any tanning agent conventionally employed for re-tanning, e.g. mineral, vegetable or synthetic tanning agents, e.g., chromium, zirconyl or aluminium derivatives, quebracho, chestnut or mimosa extracts, aromatic syntans, polyurethanes, (co) polymers of (meth)acrylic acid compounds or melamine/, dicyanodiamide/and/or urea/formaldehyde resins.

Examples of suitable compressible substrates include foam substrates, polymeric bladders filled with liquid, polymeric bladders filled with air and/or gas, and/or polymeric bladders filled with plasma. As used herein the term “foam substrate” means a polymeric or natural material that comprises a open cell foam and/or closed cell foam. As used herein, the term “open cell foam” means that the foam comprises a plurality of interconnected air chambers. As used herein, the term “closed cell foam” means that the foam comprises a series of discrete closed pores. Example foam substrates include polystyrene foams, polymethacrylimide foams, polyvinylchloride foams, polyurethane foams, polypropylene foams, polyethylene foams, and polyolefinic foams. Example polyolefinic foams include polypropylene foams, polyethylene foams and/or ethylene vinyl acetate (EVA) foam. EVA foam can include flat sheets or slabs or molded EVA forms, such as shoe midsoles. Different types of EVA foam can have different types of surface porosity. Molded EVA can comprise a dense surface or “skin”, whereas flat sheets or slabs can exhibit a porous surface.

The coating compositions of the present invention can be applied to such substrates by any of a variety of methods including spraying, brushing, dipping, and roll coating, among other methods. In certain embodiments, however, the coating compositions of the present invention are applied by spraying and, accordingly, such compositions are suitable for application by spraying at ambient conditions.

While the coating compositions of the present invention can be applied to various substrates, such as wood, metal, glass, cloth, plastic, foam, including elastomeric substrates and the like, in many cases, the substrate comprises a metal.

In certain embodiments of the coating compositions of the present invention, after application of the composition to the substrate, a film is formed on the surface of the substrate by driving solvent, i.e., organic solvent and/or water, out of the film by heating or by an air-drying period. Suitable drying conditions will depend on the particular composition and/or application, but in some instances a drying time of from about 1 to 5 minutes at a temperature of about 80 to 250° F. (20 to 121° C.) will be sufficient. More than one coating layer may be applied if desired. Usually between coats, the previously applied coat is flashed; that is, exposed to ambient conditions for about 10 to 30 minutes. In certain embodiments, the thickness of the coating is from 0.05 to 5 mils (1.3 to 127 microns), such as 0.05 to 3.0 mils (1.3 to 76.2 microns). The coating composition may then be heated. In the curing operation, solvents are driven off and the crosslinkable components of the composition, if any, are crosslinked. The heating and curing operation is sometimes carried out at a temperature in the range of from 160 to 350° F. (71 to 177° C.) but, if needed, lower or higher temperatures may be used.

The present invention is also directed to multi-component composite coatings comprising at least one coating layer deposited from a coating composition of the present invention. In certain embodiments, the multi-component composite coating compositions of the present invention comprise a base-coat film-forming composition serving as a basecoat (often a pigmented color coat) and a film-forming composition applied over the basecoat serving as a topcoat (often a transparent or clear coat).

In these embodiments of the present invention, the coating composition from which the basecoat and/or topcoat is deposited may comprise, for example, any of the conventional basecoat coating compositions known to those skilled in the art of, for example, formulating automotive OEM coating compositions, automotive refinish coating compositions, industrial coating compositions, architectural coating compositions, coil coating compositions, and aerospace coating compositions, among others. Such compositions typically include a film-forming resin that may include, for example, an acrylic polymer, a polyester, and/or a polyurethane. Exemplary film-forming resins are disclosed in U.S. Pat. No. 4,220,679, at col. 2 line 24 to col. 4, line 40; as well as U.S. Pat. No. 4,403,003, U.S. Pat. No. 4,147,679 and U.S. Pat. No. 5,071,904.

The present invention is also directed to substrates, such as metal substrates, at least partially coated with a coating composition of the present invention as well as substrates, such as metal substrates, at least partially coated with a multi-component composite coating of the present invention.

As should also be apparent from the foregoing description, the present invention is also directed to methods for reducing the average primary particle size of ultrafine particles produced from a precursor in a vapor phase synthesis process. Such methods comprise including an alkali metal dopant in a stream comprising the precursor prior to the precursor being heated in a high temperature chamber.

Illustrating the invention are the following examples, which, however, are not to be considered as limiting the invention to their details. Unless otherwise indicated, all parts and percentages in the following examples, as well as throughout the specification, are by weight.

### EXAMPLES

### Particle Examples 1 to 3

Particles were prepared using a DC thermal plasma system. The plasma system included a DC plasma torch (Model SG-100 Plasma Spray Gun commercially available from Praxair Technology, Inc., Danbury, Conn.) operated with 80 standard liters per minute of argon carrier gas and 24 kilowatts of power delivered to the torch. Liquid precursors feed composition comprising the materials and amounts listed in Table 1 was prepared and fed to the reactor at a rate of about 10 grams per minute through a gas assisted liquid nebulizer located 3.7 inches down stream of the plasma torch outlet. At the nebulizer, a mixture of 4.9 standard liters per minute of argon and 10.4 standard liters per minute oxygen were delivered to assist in atomization of the liquid precursors. Additional oxygen at 28 standard liters per minute was delivered through a ⅛ inch diameter nozzle located 180° apart from the nebulizer. Following a 6 inch long reactor section, a plurality of quench stream injection ports were provided that included 6⅛ inch diameter nozzles located 60° apart radially. A 10 millimeter diameter converging-diverging nozzle of the type described in U.S. Pat. No. RE 37,853E was provided 4 inches downstream of the quench stream injection port. Quench air was injected through the plurality of quench stream injection ports at a rate of 100 standard liters per minute.

TABLE 1

| | Particle | Particle | Particle |
|---|---|---|---|
| Materials | Example 1 | Example 2 | Example 3 |
| Tetraethoxysilane¹ | 561 grams | 608 grams | 554 grams |
| Aluminum Di-sec-Butoxide² | 335 grams | 363 grams | 330 grams |
| Cesium Acetate³ | — | 3 grams | 13 grams |
| Butanol | 91 grams | 23 grams | 90 grams |
| Methanol | 14 grams | 3 grams | 13 grams |

¹Commercially available from Sigma Aldrich Co., St Louis, Missouri.
²Commercially available from Chattem Chemicals, Inc, Chattanooga, TN.
³Commercially available from Alfa Aesar, Ward Hill, Massachusetts.

Theoretical composition of the produced particles and their properties are listed in the Table 2. The calculations were based that on one mole of Tetraethoxysilane can produce one mole of SiO₂, one mole of Aluminum Di-sec-Butoxide can produce one half mole of Al₂O₃, and one mole of Cesium acetate can produce one half mole of Cs₂O. Butanol and methanol were the additional solvents in the formula that generated no oxide particles after complete oxidation reactions in the thermal plasma system. B.E.T. specific surface area was measured using a Gemini model 2360 analyzer (available from Micromeritics Instrument Corp., Norcross, Ga.). Acidity of the produced materials was prepared in dispersion and measured using a pH meter (OAKTON model 510, available from Oakton Instruments, Vernon Hills, Ill.). The dispersion was prepared by adding two grams of the produced powder to 50 grams of de-ionic water in a beaker. pH value of the dispersion was measured after 10 minutes of agitation using a magnetic stirrer. The data showed higher BET surface area and pH for the samples doped with cesium salt.

TABLE 2

| | Particle | Particle | Particle |
|---|---|---|---|
| Composition and Properties | Example 1 | Example 2 | Example 3 |
| SiO₂ | 70% | 69.41% | 66.99% |
| Al₂O₃ | 30% | 29.95% | 28.71% |
| Cs₂O | 0% | 0.84% | 4.31% |
| B.E.T. Surface area (m²/g) | 96 | 186 | 215 |
| pH | 4.2 | 5.4 | 6.3 |

### Particle Examples 4 and 5

Particles from liquid precursors were prepared using the apparatus and conditions identified in Examples 1 to 3 and the feed materials and amounts listed in Table 3.

TABLE 3

| | Particle | Particle |
|---|---|---|
| Materials | Example 4 | Example 5 |
| Tetraethoxysilane | 558 grams | 555 grams |
| Aluminum Di-sec-Butoxide | 333 grams | 331 grams |
| Potassium Acetate⁴ | 5 grams | 10 grams |
| Butanol | 90 grams | 90 grams |
| Methanol | 14 grams | 13 grams |

⁴Commercially available from Alfa Aesar, Ward Hill, Massachusetts.

Theoretical composition of the produced particles and their properties are listed in the Table 4. The calculations were based on that one mole of Tetraethoxysilane can produce one mole of SiO₂, one mole of Aluminum Di-sec-Butoxide can produce one half mole of Al₂O₃, and one mole of Potassium acetate can produce one half mole of K₂O. Butanol and methanol were the additional solvents in the formula that generated no oxide particles after complete oxidation reactions in the thermal plasma system. B.E.T. specific surface area was measured using a Gemini model 2360 analyzer. Acidity of the produced materials was prepared in dispersion and measured using a pH meter (OAKTON model 510). The dispersion was prepared by adding two grams of the produced powder to 50 grams of de-ionic water in a beaker. pH value of the dispersion was measured after 10 minutes of agitation using a magnetic stirrer. The data showed higher BET surface area and pH for the samples doped with potassium salt.

TABLE 4

| | Particle | Particle | Particle |
|---|---|---|---|
| Composition and Properties | Example 1 | Example 4 | Example 5 |
| SiO₂ | 70% | 69.27% | 68.41% |
| Al₂O₃ | 30% | 29.69% | 29.32% |
| K₂O | 0% | 1.04% | 2.27% |
| B.E.T. Surface area (m²/g) | 96 | 203 | 204 |
| pH | 4.2 | 6.1 | 6.5 |

### Particle Examples 6 and 7

Particles from liquid precursors were prepared using the apparatus and conditions identified in Examples 1 to 3 and the feed materials and amounts listed in Table 5.

TABLE 5

| | Particle | Particle |
|---|---|---|
| Materials | Example 6 | Example 7 |
| Tetraethoxysilane | 95.5 grams | 95.5 grams |
| Zinc 2-Ethylhexanoate⁵ | 97.3 grams | 97.3 grams |
| Triethyl Phosphate⁶ | 128.3 grams | 128.3 grams |
| Lithium 2-4 Pentanedionate⁷ | — | 7.1 grams |
| Methanol | — | 60 grams |

⁵Commercially available from Alfa Aesar, Ward Hill, Massachusetts.
⁶Commercially available from Alfa Aesar, Ward Hill, Massachusetts.
⁷Commercially available from Alfa Aesar, Ward Hill, Massachusetts.

Theoretical composition of the produced particles and their properties are listed in the Table 6. The calculations were based on that one mole of Tetraethoxysilane can produce one mole of SiO₂, one mole of Zinc 2-ethylhexanoate can produce one mole of ZnO, one mole of Triethyl phosphate can produce one half mole of P₂O₅, and one mole of Lithium 2-4 pentanedionate can produce one half mole of Li₂O. Butanol and methanol were the additional solvents in the formula that generated no oxide particles after complete oxidation reactions in the thermal plasma system. B.E.T. specific surface area was measured using a Gemini model 2360 analyzer. Acidity of the produced materials was prepared in dispersion and measured using a pH meter (OAKTON model 510). The dispersion was prepared by adding two grams of the produced powder to 50 grams of de-ionic water in a beaker. pH value of the dispersion was measured after 10 minutes of agitation using a magnetic stirrer. The data showed higher BET surface area and pH for the samples doped with lithium salt.

TABLE 6

| | Particle | Particle |
|---|---|---|
| Composition and Properties | Example 6 | Example 7 |
| SiO₂ | 27.5% | 27.3% |
| ZnO | 22.5% | 22.3% |
| P₂O₅ | 50% | 49.4% |
| Li₂O | 0% | 1% |
| B.E.T. Surface area (m²/g) | 4 | 43 |
| pH | 2.2 | 2.7 |

### Particle Examples 8 and 9

Particles from liquid precursors were prepared using the apparatus and conditions identified in Examples 1 to 3 and the feed materials and amounts listed in Table 7.

TABLE 7

| | Particle | Particle |
|---|---|---|
| Materials | Example 8 | Example 9 |
| Tetraethoxysilane | 539 grams | 537 grams |
| Aluminum Di-sec-Butoxide | 322 grams | 321 grams |
| Cesium Floride⁸ | 31 grams | 41 grams |
| Butanol | 77 grams | 87 grams |
| Methanol | 31 grams | 13 grams |

⁸Commercially available from Alfa Aesar, Ward Hill, Massachusetts.

Theoretical composition of the produced particles and their properties are listed in the Table 8. The calculations were based on that one mole of Tetraethoxysilane can produce one mole of SiO₂, one mole of Aluminum Di-sec-Butoxide can produce one half mole of Al₂O₃, and one mole of Cesium fluoride can produce one mole of CsF. Butanol and methanol were the additional solvents in the formula that generated no oxide particles after complete oxidation reactions in the thermal plasma system. B.E.T. specific surface area was measured using a Gemini model 2360 analyzer. Acidity of the produced materials was prepared in dispersion and measured using a pH meter (OAKTON model 510). The dispersion was prepared by adding two grams of the produced powder to 50 grams of de-ionic water in a beaker. pH value of the dispersion was measured after 10 minutes of agitation using a magnetic stirrer. The data showed higher BET surface area and pH for the samples doped with cesium salt.

TABLE 8

| | Particle | Particle | Particle |
|---|---|---|---|
| Composition and Properties | Example 1 | Example 8 | Example 9 |
| SiO₂ | 70% | 61.41% | 51.08% |
| Al₂O₃ | 30% | 26.32% | 21.89% |
| CsF | 0% | 12.27% | 27.03% |
| B.E.T. Surface area (m²/g) | 96 | 199 | 184 |
| pH | 4.2 | 6.2 | 6.1 |

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A method for making ultrafine particles, comprising:
(a) introducing a plurality of precursors to a high temperature chamber, the precursors comprising:
(i) a first precursor; and
(ii) a second precursor different from the first precursor and comprising an alkali metal dopant;
(b) heating the plurality of precursors in the high temperature chamber, yielding a gaseous product stream;
(c) quenching the gaseous product stream, thereby producing ultrafine particles; and
(d) collecting the ultrafine particles.

2. The method of claim 1, wherein the ultrafine particles have a B.E.T. specific surface area of 90 to 500 square meters per gram.

3. The method of claim 1, wherein the ultrafine particles have an average primary particle size of no more than 20 nanometers.

4. The method of claim 1, wherein the ultrafine particles comprise silica and/or alumina.

5. The method of claim 1, wherein the alkali metal comprises lithium, sodium, potassium, and/or cesium.

6. The method of claim 1, wherein the second precursor comprises a liquid.

7. The method of claim 6, wherein the second precursor comprises cerium acetate, cerium nitrate, cerium ammonium nitrate, cerium carbonate, cerium chloride, cerium fluoride, cerium oxide, sodium nitrate, sodium nitrite, sodium acetate, sodium chloride, sodium carbonate, sodium oxide, sodium fluoride, potassium carbonate, potassium oxide, potassium nitrate, potassium chloride, or a mixture thereof.

8. The method of claim 1, wherein the second precursor is introduced in an amount such that the ultrafine particles theoretically include 0.01 to 15 weight percent of the alkali metal component, with weight percent being based on the total weight of the ultrafine particle.

9. The method of claim 8, wherein the second precursor is introduced in an amount such that the ultrafine particles theoretically include 0.1 to 2 weight percent of the alkali metal component, with weight percent being based on the total weight of the ultrafine particle.

10. The method of claim 1, wherein the method provides at least a 50% reduction in the average primary particle size of the ultrafine particles produced, as compared to utilizing an identical process absent the use of a second precursor comprising an alkali metal dopant.

11. The method of claim 10, wherein the reduction is at least 100%.

12. The method of claim 1, wherein the high temperature chamber comprises a plasma chamber.

13. The method of claim 1, wherein the quenching is performed by contacting the gaseous product stream with a plurality of quench streams injected into the high temperature chamber through a plurality of quench stream injection ports, wherein the quench streams are injected at flow rates and injection angles that result in the impingement of the quench stream with each other within the gaseous product stream.

14. Ultrafine particles produced from a plurality of precursors comprising:
(a) a first precursor; and
(b) a second precursor different from the first precursor and comprising an alkali metal dopant.

15. The ultrafine particles of claim 14, wherein the particles are produced by a gas phase synthesis process.

16. A composition comprising ultrafine particles produced by the method of claim 1.

17. The composition of claim 16, wherein the composition is a coating composition.

18. A substrate at least partially coated with the coating composition of claim 17.

19. A method for reducing the average primary particle size of ultrafine particles made by a vapor phase synthesis process comprising: (a) including an alkali metal dopant in a precursor stream to a high temperature chamber, wherein the precursor stream comprises at least one organometallic and/or inorganic oxide precursor which is different from the alkali metal dopant; (b) heating the precursor stream in the high temperature chamber, yielding a gaseous product stream; (c) quenching the gaseous product stream, thereby producing ultrafine particles; and (d) collecting the ultrafine particles.

20. A plasma reactor apparatus for the production of ultrafine particles comprising:
(a) a plasma chamber having axially spaced inlet and outlet ends;
(b) a high temperature plasma positioned at the inlet end of the plasma chamber;
(c) an inlet for introducing a precursor stream to the plasma chamber, the precursor stream comprising:
(i) a first precursor; and
(ii) a second precursor different from the first precursor and comprising an alkali metal dopant, wherein the precursor stream is heated by the plasma to produce a gaseous product stream flowing toward the outlet end of the plasma chamber;
(d) means for quenching the gaseous product stream, thereby producing ultrafine particles, and
(e) means for collecting the ultrafine particles.
